(19) United States
(12) Patent Application Publication
(10) Pub. No.: US 2007/0254528 A1
(43) Pub. Date: Nov. 1, 2007

(54) Electronic device

(75) Inventors: Sheng-Hsiung Chang, Taipei (TW); Yu-Chen Lee, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/797,055

(22) Filed: Apr. 30, 2007

(30) Foreign Application Priority Data
May 1, 2006 (TW) 95115493

(51) Int. Cl. H01R 24/04

(52) U.S. Cl. 439/668

(57) ABSTRACT

An electronic device for electrically connecting a first audio module to a speaker is described. The electronic device includes a case, a circuit board, a first audio connector, a second audio connector, and an internal music module. Both the first audio connector and the second audio connector are disposed on the circuit board. The speaker electrically connects to the first audio connector, and the second audio connector electrically connects to the first audio module and the first audio connector. The electronic device preferably includes an audio input interface. At least part of the audio input interface is fixed on the case and thereby users can conveniently connect the first audio module to the electronic device.

### RELATED APPLICATIONS

This application claims priority to Taiwan Application Serial Number 95115493, filed May 1, 2006, which is herein incorporated by reference.

### FIELD OF THE INVENTION

The present invention generally relates to an electronic device. More particularly, this invention relates to a computer with a second audio connector.

### BACKGROUND OF THE INVENTION

Since the industrial technology and the semiconductor technology are highly developed, electronic devices are becoming increasingly light, and easy to hold. Therefore, these kinds of portable electronic devices, such as notebook computers, portable televisions, mobile phones, personal digital assistants (PDA), and multimedia players, for example, MP3 (MPEG audio layer 3) players, are becoming thinner, lighter, shorter and smaller.

Small modern portable multimedia players, such as the MP3 player, store numerous compressed music files therein. Users normally use earphones to listen to the music stored on the portable media player. However, hearing impairment caused by the long-term use of earphones to listen to music and the additional distraction caused to listeners who are trying to concentrate on their work have resulted in many users routing their portable multimedia player to speakers through their computers.

However, to listen to music through the computer, the computer must first be turned on. Then the computer must connected to the MP3 player through, for example, a universal serial bus (USB) port so that the music can be transmitted from the MP3 player, into the computer and broadcast through the external speakers connected with the music output connector of the computer.

Alternatively, some users may broadcast the music through the external speakers by drawing out the connector of the external speakers from the music output connector of the computer and inserting it directly into the music output connector of the MP3 player.

However, the foregoing broadcast steps to play the music through the external speakers of the computer are too complicated for the user just only wanting to listen to music. In some computer models, drawing out the connector of the external speaker from the music output connector of the computer and inserting it into the music output connector of the MP3 player are especially difficult and very inconvenient for the users.

### SUMMARY OF THE INVENTION

One object of the present invention is to provide an electronic device, e.g. a computer, with a second audio connector disposed on the circuit board of the electronic device to electrically connect an external music player.

Another object of the present invention is to provide an electronic device, e.g. a computer, with a second audio connector disposed on the motherboard and directly electrically connected to a first audio connector of the motherboard so as to allow an external music player electrically connected with the second audio connector broadcasting music through an external computer speaker electrically connected with the first audio connector.

Further another object of the present invention is to provide an electronic device, e.g. a computer, with a second audio connector disposed on the motherboard to electrically connect to a first audio connector of the motherboard through a route selection circuit to control whether the music played by an external music player electrically connected with the second audio connector is transmitted to an external computer speaker electrically connected with the first audio connector.

Yet another object of the present invention is to provide an electronic device, e.g. a computer, with a second audio connector disposed on the motherboard and an audio input interface disposed on the computer chassis so that users can conveniently connect an external music player to the audio input interface and the audio signals played by the external music player can easily be transmitted to a computer speaker electrically connected with the computer.

To achieve these and other advantages and in accordance with the purpose of the present invention, as embodiment and broadly described herein, the present invention provides an electronic device for electrically connecting to a first audio module and a speaker. The electronic device comprises a case, a circuit board, a second audio module, a first audio connector and a second audio connector. The circuit board and the second audio module are both disposed in the case. The first audio connector is disposed on the circuit board and electrically connected to the speaker. The second audio connector is disposed on the circuit board. First end of the second audio connector is electrically connected to the first audio module and second end of the second audio connector is electrically connected to the first audio connector.

The electronic device preferably further includes an audio input interface. The audio input interface includes a phone jack electrically connected to the first audio module and a signal wire electrically connected to the phone jack and the second audio connector. At least a part of the phone jack is disposed on the case. The audio input interface preferably includes a fixing bracket fixed on the case and the phone jack penetrates the fixing bracket.

The first audio module is preferably an external MP3 (MPEG audio layer 3) player and the second audio module is preferably an internal optical disc drive. The second audio connector is preferably a BOX header connector with a foolproof function to be preventing from incorrect insertion. The first audio connector is preferably an audio phone jack.

The electronic device preferably includes a route selection circuit disposed between the first audio connector and the second audio connector to control the electrical connection of the second audio connector and the first audio connector. The electronic device can use the chipset and the general-purpose input/output (GPIO) circuit thereof to control the route selection circuit.

The route selection circuit includes a first NPN transistor and a second NPN transistor connecting to the GPIO circuit, and a first N-channel Metal-Oxide-Semiconductor Field Effect Transistor (N-channel MOSFET) and a second N-channel MOSFET connecting to the first NPN transistor and the second NPN transistor so as to control the electrical connections of the second audio connector and the right and left speaker terminals of the first audio connector.

When the GPIO circuit provides a high voltage signal, the first N-channel MOSFET and the second N-channel MOSFET disconnect the electrical connections of the right and left speaker terminals of the first audio connector from the second audio connector. The GPIO circuit electrically connects to the chipset of the circuit board. Preferably, the first audio connector maintains an electrical connection with the second audio connector when the circuit board is turned off.

Hence, the electronic device according to the present invention can utilize the second audio connector and the audio input interface to conveniently connect to a portable music player and the computer speaker for the user. The music played by the portable music player can easily be broadcast by the external computer speaker whether the electronic device is turned on or not.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates an embodiment of the electronic device according to the present invention; and

FIG. 2 illustrates another embodiment of the electronic device according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

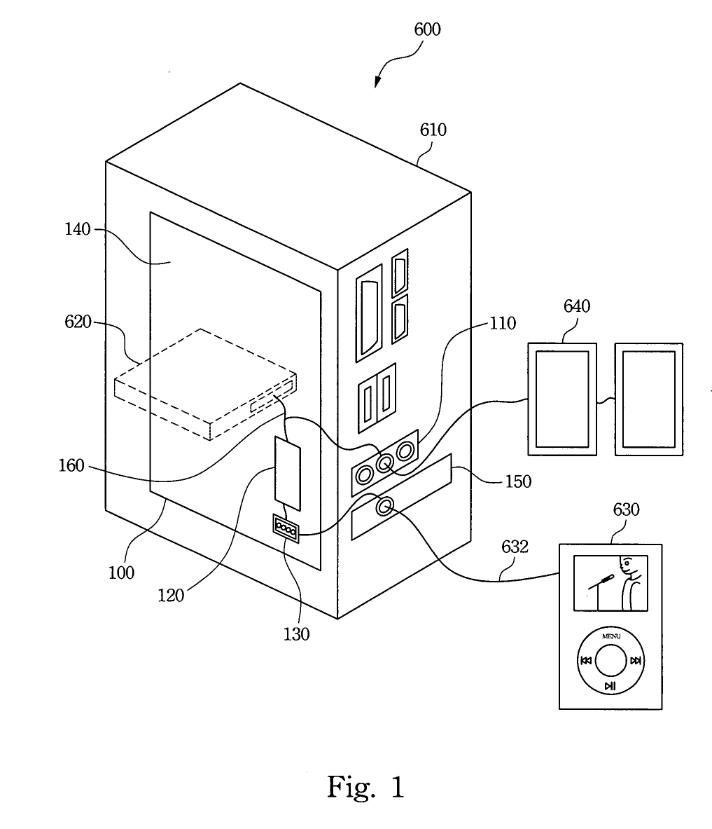

FIG. 1 is an embodiment of the electronic device according to the present invention. The electronic device 600, preferably a computer, includes a case 610, a circuit board 100, e.g. a motherboard, and a second audio module 620, e.g. an internal optical disc drive.

The circuit board 100 includes a printed circuit board 140, a first audio connector 110, a connecting circuit 120 and a second audio connector 130. The first audio connector 110 is a traditional voice input/output interface. In general, the traditional voice input/output interface includes a microphone input connector (MIC input), a voice input connector (line input) and a speaker output connector (Spk out). In the present invention, the speaker output connector is the first audio connector 110. In addition, the traditional voice input/output interface is controlled by a chipset of the central processing unit (CPU). Therefore, normally the chipset controls the traditional voice input/output interface when the computer is turned on.

The second audio connector 130 is configured on the printed circuit board 140 and connected to the first audio connector 110 through the connecting circuit 120. The first audio connector 110 can directly connect to an external computer speaker 640 to broadcast the audio signals transmitted from the first audio connector 110. Therefore, the audio signals played by a first audio module 630, e.g. an external music player, electrically connected to the second audio connector 130 can also be broadcast by the external computer speaker 640 through the first audio connector 110. The second audio connector 130 can further be connected to an audio input interface 150 configured on the case so that users can conveniently connect a signal output wire 632 of the first audio module 630 to the electronic device 600. The second audio module 620 is therefore electrically connected to the first audio connector 110 through the connecting circuit 160 to broadcast the music played by the second audio module 620 from the speaker 640.

In addition, the connecting circuit 120 is preferably a signal transmission line. First end of the signal transmission line is connected to the first audio connector 110 and second end is connected to the second audio connector 130 to directly transmit audio signals to the first audio connector 110 and broadcast the audio signals by the external computer speaker 640. The connecting circuit 120 can be patterned in the printed circuit board 140. In addition, the connecting circuit 120 can be a route selection circuit to electrically connect the first audio connector 110 and the second audio connector 130 to determine whether the first audio connector 110 electrically connects the second audio connector 130 when the circuit board 100 is turned on. Preferably, the first audio connector 110 electrically connects to the second audio connector 130 through the route selection circuit when the circuit board 100 is turned off to allow the external music player broadcasting the audio signals from the external computer speaker 640 through the first audio connector 110 even though the electronic device 600 is turned off.

The second audio connector is preferably a box header connector with a foolproof function to prevent incorrect insertion. The external music player is preferably an MP3 player (MPEG audio layer 3 player) to store a large amount of music files therein.

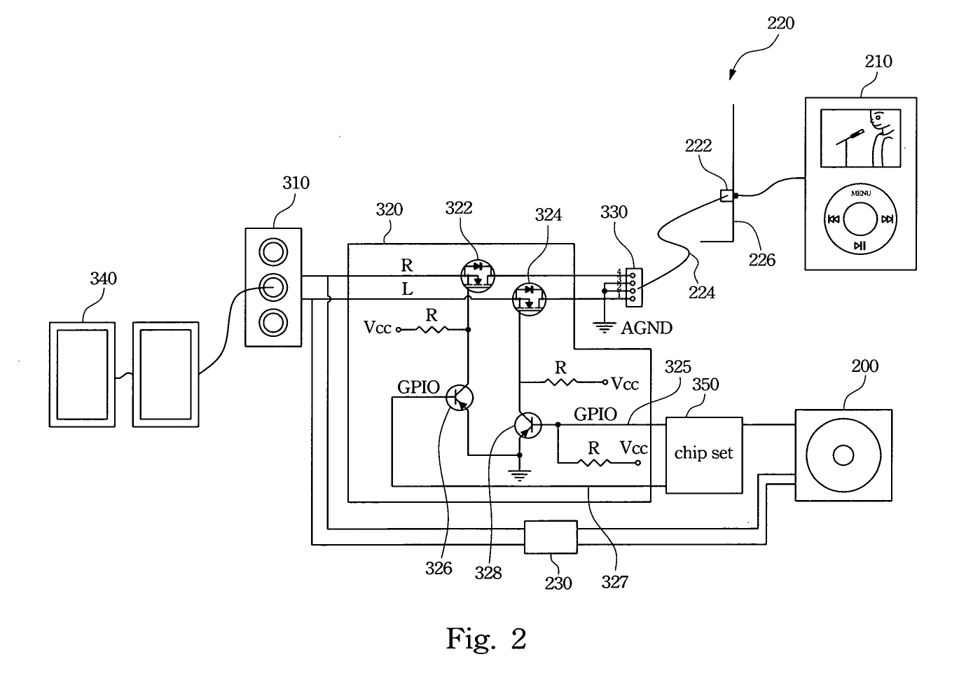

Referring to FIG. 2, another embodiment of the electronic device according to the present invention is illustrated. A route selection circuit 320 is disposed between the first audio connector 310 and the second audio connector 330, for example, a box header connector. The route selection circuit 320 is preferably composed of a first N-channel MOSFET 324, a first NPN transistor 328, a second N-channel MOSFET 322 and a second NPN transistor 326. The first NPN transistor 328 and the second NPN transistor 326 are respectively connected to the GPIO (general-purpose input/output) circuit 325 and the GPIO circuit 327 to receive the control signals from the chipset 350. When the GPIO circuit 325 and GPIO circuit 327 output high voltage signals, the first NPN transistor 328 and the second NPN transistor 326 are turned on so that the first N-channel MOSFET 324 and the second N-channel MOSFET 322 are turned off to disconnect right and left speaker terminals of the first audio connector 310 from the second audio connector 330.

When the GPIO circuit 325 and the GPIO circuit 327 output low level voltage signals, the first NPN transistor 328 and the second NPN transistor 326 are turned off so that the first N-channel MOSFET 324 and the second N-channel MOSFET 322 are turned on to electrically connect the right and left speaker terminals of the first audio connector 310 to the second audio connector 330.

Therefore, when the motherboard is turned off and only provides the supply voltage Vcc, the route selection circuit 320 is turned on, that is, the first audio connector 310 is electrically connected to the second audio connector 330. Therefore, the external music player can transmit the audio signals to the speaker 340 through the second audio connector 330, the route selection circuit 320 and the first audio connector 310.

The optical disc drive 200 is controlled by a chipset 350 and the audio signals thereof are transmitted to the first audio connector 310 and broadcast by the speaker 340 through the audio chip 230. In addition, the audio input interface 220 preferably includes a phone jack 222 to electrically connect the MP3 player 210 and a signal wire 224 to electrically connect to the second audio connector 330. The audio input interface 220 preferably further includes a fixing bracket 226 to be fixed on the computer case, and the phone jack 222 is fixed thereon and penetrated there through. Hence, a user can conveniently connect an MP3 player 210 to the audio input interface 220.

In addition, the electronic device according to the present invention can further includes control software therein to control the GPIO circuit to turn on or off the route selection circuit when the computer is turned on.

Accordingly, the electronic device according to the present invention can be easily connected to a portable music player by a user through the audio input interface so that the portable music player can be conveniently and electrically connected to the first audio connector. The external computer speaker can therefore easily broadcast music played by the portable music player. The user does not have to pull the connector of the speaker out the first audio connector and then couple the connector of the speaker to the portable music player. In addition, the user can broadcast the music played by the portable music player with the computer speaker whether the computer is turned on or not. With the route selection circuit, the music played by the portable music player can effectively be prevented from being mixed with the voice generated by the computer.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An electronic device for electrically connecting to a first audio module and an speaker, the electronic device comprising:
a case;
a printed circuit board disposed in the case;
a second audio module disposed in the case;
a first audio connector set on the printed circuit board, the speaker electrically connected to the first audio connector and the second audio module electrically connected to the first audio connector; and
a second audio connector disposed on the printed circuit board, a first end of the second audio connector electrically connected to the first audio module and a second end of the second audio connector electrically connected to the first audio connector.

2. The electronic device of claim 1, further comprising an audio input interface, wherein the audio input interface comprises:
a phone jack, at least one part of the phone jack set on the case to connect to the first audio module; and
a signal wire electrically connecting the phone jack to the second audio connector.

3. The electronic device of claim 2, wherein the audio input interface further comprises a fixing bracket fixed on the case and the phone jack penetrates through the fixing bracket.

4. The electronic device of claim 1, wherein the first audio module is an external MP3 (MPEG audio layer 3) player and the second audio module is an internal optical disc drive.

5. The electronic device of claim 1, wherein the second audio connector is a BOX header connector and the first audio connector is an audio phone jack.

6. The electronic device of claim 1, further comprising a route selection circuit disposed between the first audio connector and the second audio connector to determine the electrical connection of the second audio connector and the first audio connector.

7. The electronic device of claim 6, further comprising a general-purpose input/output (GPIO) circuit set on the circuit board to control the route selection circuit.

8. The electronic device of claim 7, wherein the route selection circuit comprises:
a first NPN transistor connecting to the GPIO circuit; and
a first N-channel Metal-Oxide-Semiconductor Field Effect Transistor (N-channel MOSFET) connecting to the first NPN transistor to control an electrical connection of the second audio connector and a left speaker terminal of the first audio connector.

9. The electronic device of claim 8, wherein the route selection circuit further comprises:
a second NPN transistor connecting to the GPIO circuit; and
a second N-channel MOSFET connecting to the second NPN transistor to control an electrical connection of the second audio connector and a right speaker terminal of the first audio connector.

10. The electronic device of claim 9, wherein the first N-channel MOSFET and the second N-channel MOSFET disconnect the right speaker terminal and the left speaker terminal of the first audio connector from the second audio connector when the GPIO circuit provides a high voltage signal.

11. The electronic device of claim 7, further comprising a control software to control the GPIO circuit to turn on or off the route selection circuit.
